(19) United States
(12) Patent Application Publication
(10) Pub. No.: US 2026/0131179 A1
(43) Pub. Date: May 14, 2026

(54) INLINE VALVE FOR SPRINKLER HEAD REPLACEMENT

(71) Applicant: Sprinkler Stop, LLC, Pompano Beach, FL (US)

(72) Inventor: Fred D. Moore, Collegeville, PA (US)

(73) Assignee: Sprinkler Stop, LLC, Pompano Beach, FL (US)

(21) Appl. No.: 19/379,146

(22) Filed: Nov. 4, 2025

Related U.S. Application Data
(60) Provisional application No. 63/718,152, filed on Nov. 8, 2024.

(51) Int. Cl. A62C 35/68

(52) U.S. Cl. CPC A62C 35/68

(57) ABSTRACT

A self-closing sprinkler valve assembly for fire suppression or irrigation systems. A valve body includes a fluid supply connection port, a sprinkler head connection port, and a hollow cavity extending between the fluid supply and sprinkler head connection ports. A separate valve plunger housing is received within the valve body. A valve plunger is slidably received within an inner cavity created by the valve plunger housing and the valve body. The valve plunger is slidably movable within the inner cavity between an extended closed position wherein a valve plunger port and a plunger housing port are not aligned when a sprinkler head is not connected, and a retracted open position wherein the valve plunger port and the plunger housing port are aligned when a sprinkler head connection is made to the sprinkler head connection port. A sprinkler head adapter fitting allows use with different sprinkler head sizes and thread patterns.

### CROSS-REFERENCE TO RELATED APPLICATIONS

This application claims the benefit of U.S. Provisional Patent Application No. 63718152, filed November 8, 2024, the entire contents of which are incorporated herein by reference.

### BACKGROUND OF THE DISCLOSURE

(1) Field of the Invention: The instant invention relates to fire protection sprinkler systems and irrigation systems and more specifically relates to a valve for installation at the terminal ends of sprinkler and irrigation lines just prior to the sprinkler head itself wherein the sprinkler line is automatically sealed to prevent flow of fluid from the system when the sprinkler head is removed, yet allows full flow when a sprinkler head is installed.

(2) Background of the Invention: It is not uncommon that a sprinkler head becomes damaged and needs to be removed and replaced due to leakage, to change the spray pattern, to change the temperature rating or for some other defect.

Generally, the process of changing a sprinkler head or servicing a sprinkler or irrigation system requires that the entire system be turned off and drained, thereby disabling the entire system.

In the case of fire protection systems, this leaves the structure unprotected for the duration of the service operation and complicates the scheduling of such service through the need to coordinate with fire departments and the requirement of posting fire watches. In addition, the service operation requires additional time in order to drain the system of fire protection fluid, which is usually water and/or a mixture with antifreeze under pressure, remove and replace the sprinkler head, and then recharge the system with appropriate fire-retardant fluid. This service operation usually requires several man hours to perform.

In the case of irrigation systems, disabling the watering system may impede regularly scheduled watering cycles and if left disabled for extended periods of time may potentially damage crops.

Accordingly, there is a need for a valve system that eliminates the need to drain and recharge an irrigation or fire suppression system whenever a sprinkler head must be serviced.

### SUMMARY OF THE DISCLOSURE

According to exemplary embodiments of the invention, a terminal valve fixture for installation at the end of a sprinkler head (such as in a fire protection system or an irrigation system) comprises an automatic self-closing valve device that operates in response to the installation or removal of a sprinkler head from the fixture itself.

It is important to understand that the present valve is operable while the overall system is maintained at full pressure and operational status. As will be described in detail below, when the sprinkler head is removed (with the system still pressurized), the present valve operates to automatically close the end of the sprinkler feed line to prevent flow of water or fire suppression fluid while the sprinkler head is changed or replaced. When a sprinkler head is reinstalled into the valve, the valve plunger is automatically displaced to an open position to restore full and unobstructed flow to the sprinkler head returning the individual supply feed to full and operable status. In this manner, no manual shut-off valves need to be added to the system which could prevent failsafe operation.

The terminal fixture generally comprises an automatic inline valve. The in-line valve comprises a valve body with first and second portions, and an operable valve plunger within the valve body wherein a flow path is defined within the valve body and the valve plunger.

The valve body includes a connection point (input) in the first body portion for attachment to a feed line in the form of a sprinkler drop or an irrigation supply line, and a connection point (output) in the second body portion for the installation of a sprinkler head.

The first and second portions of the valve body are separable by a threaded connection to allow access to the interior of the valve body for assembly and servicing of the operable valve plunger within the valve body. The two connection points are preferably threaded for connection with the feed piping and the sprinkler head. In the case of CPVC connections, the connection point for the feed pipe may be a glued-on slip joint for connection to the feed pipe using the appropriate CPVC adhesive system.

The valve plunger is slidably received within the valve body and is preferably hollow and includes a radial valve port in the side thereof.

A pair of sealing rings are installed on the valve plunger above the valve port. The valve plunger further includes a neck at the second end that extends into the sprinkler head connection port in the second valve body portion and is hollow thereby providing a flow channel between the radial valve port and the sprinkler head. The valve plunger is spring biased with a coil spring that is captured between the first end of the plunger and an inner plunger housing. The inner plunger housing also has radial flow ports to allow fluid flow from within the valve body to flow through the plunger housing into the interior thereof.

An important aspect of the invention is a sprinkler head adapter fitting which may be configured in several different sizes and thread patterns to accommodate various types of sprinkler head thread sizes thereby allowing widespread use of the same valve in different settings. The adapter fitting has a valve body connection port at a first end and a sprinkler head adapter connection port at a second end. As noted above, the sprinkler head adapter connection portion may comprise one of a plurality of different sizes and thread patterns to accommodate varying sprinkler head connection fittings.

The sprinkler head and adapter fitting are typically pre-assembled as a unit for installation.

When the valve body is connected to a supply line at the first end and no adapter/ sprinkler head assembly is installed at the second end, the valve plunger resides in an extended, closed position with the plunger valve port positioned below the housing plunger housing valve portion body and flow being sealed by the two sealing rings which straddle the plunger housing flow port. The sealing rings prevents flow of water or fire protection fluid to the sprinkler head in this position allowing removal and replacement of the sprinkler head.

When the adapter/sprinkler head assembly is installed (threaded into the lower body portion), the valve plunger is pressed into the valve body by the adapter fitting as it is threaded into the sprinkler head connection point. When fully installed, the adapter fitting depresses the valve plunger thereby positioning the plunger valve port in alignment with the plunger housing valve portion. In this position, water or fire protection fluid is freely allowed to flow from the feed line to the sprinkler head.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary embodiment of an inline self-closing valve in accordance with the teachings of the present disclosure;

FIG. 2 is an enlarged view thereof;

FIG. 3 is an exploded view thereof;

FIG. 4 is a view of the valve plunger;

FIG. 5 is a view of the valve plunger inserted into the second valve body with the spring placed in position on the top;

FIG. 6 is a view thereof with the plunger housing positioned over the plunger;

FIG. 7 is another view thereof with the plunger housing threaded down into its installed position;

FIG. 8 is a view thereof with the first valve body located for assembly;

FIG. 9 is a view thereof with the first body threaded into position on the second valve body;

FIG. 10 is a view of the inline valve with the sprinkler head installed into the adapter fitting and ready for further assembly with the valve body.

FIGS. 11 and 12 show compression of the valve plunger into the plunger housing to open the valve; and

FIGS. 13 and 14 show the valve plunger in its normal extended position closing the valve.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

Referring now to the drawing figures, and according to exemplary embodiments of the invention, a terminal valve fixture is provided for installation at the end of a sprinkler feed 10 (such as in a fire protection system) comprises an automatic valve device 12 that operates in response to the installation or removal of a sprinkler head 14 from the fixture itself.

The exemplary embodiment described hereinbelow and illustrated in the figures is directed to a fire suppression sprinkler system. However, as noted herein, the valve device 12 is equally operable and functional for other sprinkler or irrigation systems for providing water. It is also important to understand that the present valve 12 is designed specifically to be operable while the overall water or fluid supply system is maintained at full pressure and operational status so as not to disturb other sprinkler heads during the replacement of a single head.

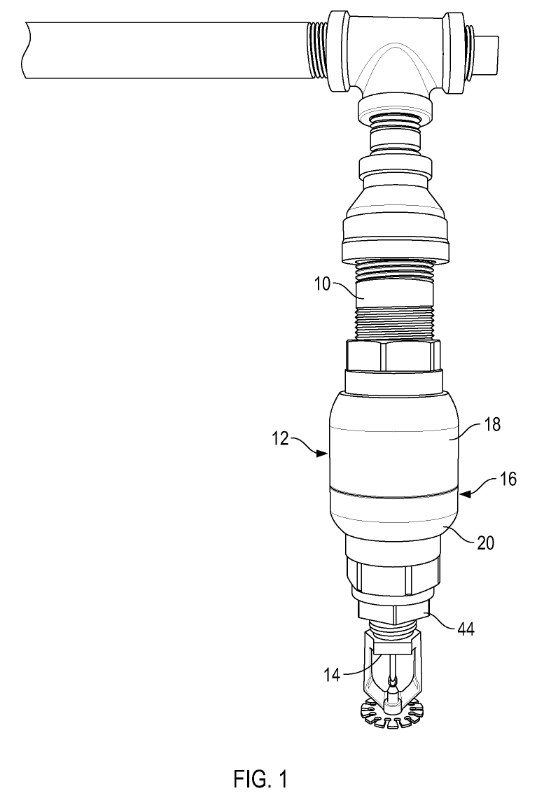

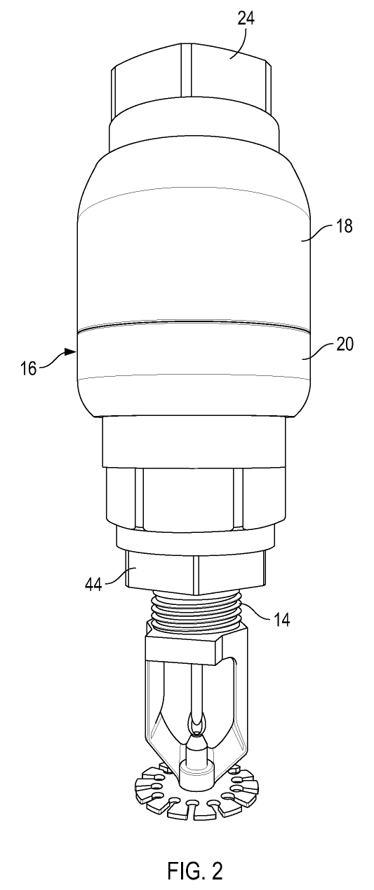

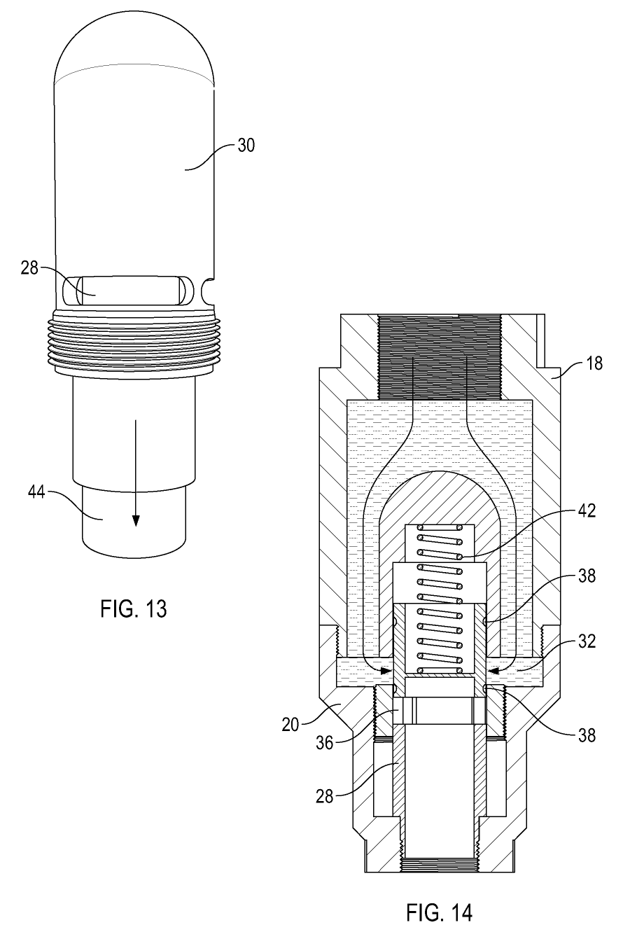

As will be described in further detail below, when the sprinkler head 14 is removed, the valve 12 operates to close the end of the sprinkler feed line 10 to prevent flow of fire protection fluid or water (See FIGS. 13 and 14). When a sprinkler head 14 is reinstalled into the valve 12, an internal valve plunger is automatically displaced to an open position to restore full and unobstructed flow to the sprinkler head 14 returning the feed location to full and operable status (See FIGS. 1, 2, 11 and 12). In this manner, no manual shut-off valves need to be added to the system which could prevent failsafe operation thereof in the event that the manual valves are not re-opened or shut off for other purposes.

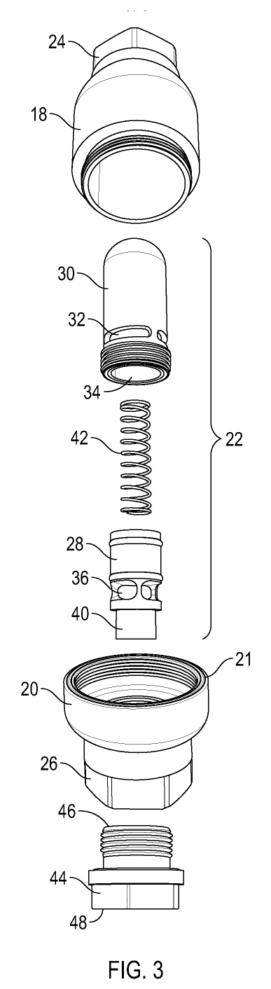

Referring now to FIG. 3, the terminal fixture comprises automatic inline valve generally indicated at 12. The valve 12 comprises a valve body 16 having first and second portions 18, 20, and an operable valve plunger assembly 22 within the valve body 16 wherein a flow path (FP) is defined through the valve body 16 and the valve plunger assembly 22.

The valve body 16 includes a connection point 24 in the first body portion 18 for attachment to the feed line 10 as illustrated in the form of a sprinkler drop, and a connection point 26 in the second body portion 20 for the installation of a sprinkler head 14.

The first and second portions 18, 20 of the valve body 16 are separable by mating threaded ends (See FIGS. 3 and 12) to allow access to the interior of the valve body for assembly and servicing of the operable valve plunger 22 within the valve body 16. The valve body 16 may be formed of any materials known to those in the field of plumbing including, but not limited to brass, cast iron, galvanized iron, galvanized steel, ductile iron, copper and/or CPVC. An O-ring gasket 21 is received in a groove on an upper peripheral edge of the second portion 20 of the valve body. The O-ring 21 creates a water-tight seal between the first and second portions 18, 20 of the valve body 16.

The two connection points 24, 26 are preferably threaded for connection with the feed piping and the sprinkler head. In the case of CPVC connections, the connection point for the feed pipe may be a glued-on slip joint (not shown) for connection to the feed pipe using the appropriate CPVC adhesive system.

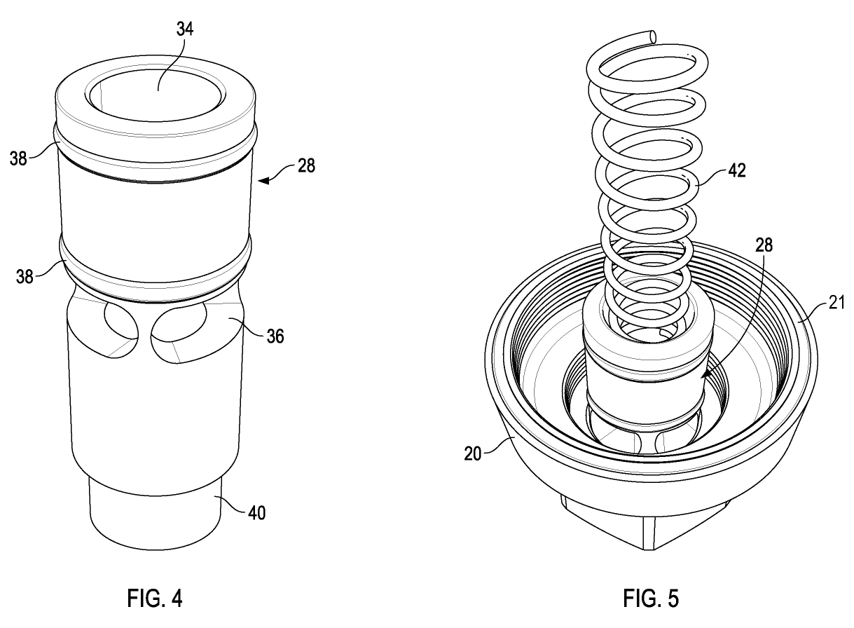

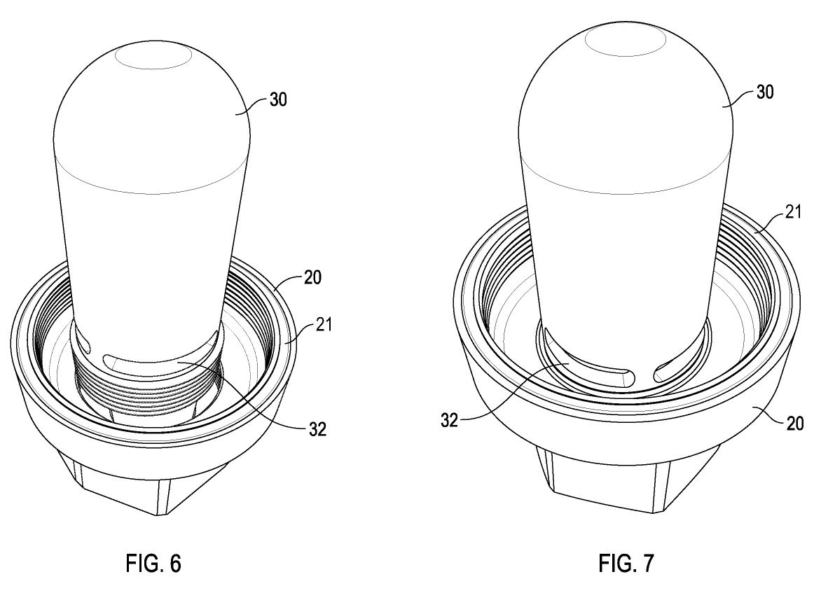

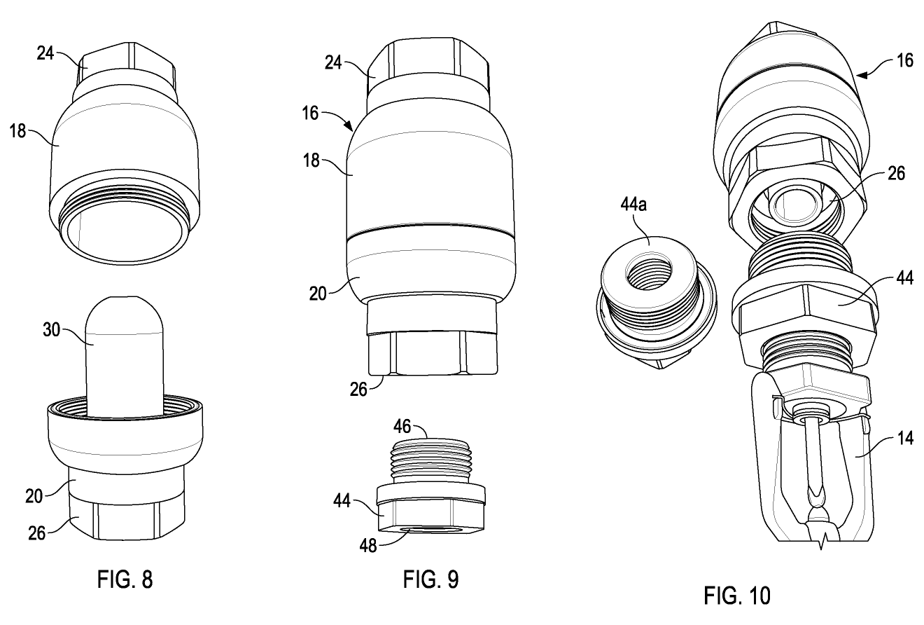

Referring now to FIG. 4, the plunger assembly 22 comprises a valve plunger 28 slidably received within an open-ended plunger housing 30. The plunger housing 30 has a hollow interior and includes a plurality of radial valve ports 32 in the sides thereof. For assembly, the open end 34 of the plunger housing 30 includes threads for connection to mating threads within the interior of the output connection port 26.

The plunger 28 also includes radial valve ports 36 opening into the interior of the plunger 28 as well as a pair of sealing O-rings 36 on the exterior of the valve plunger 28 above the plunger valve ports 36. The valve plunger 28 further includes a neck 40 at a second end that extends into the sprinkler head connection port 26 in the second valve body portion 20. The plunger 28 and neck 40 are hollow to provide a flow channel between the radial valve ports 36 to the sprinkler head 14. The valve plunger 28 is spring biased with a coil spring 42 captured between a closed end of the plunger 28 and an inner surface of the plunger housing 30. The radial flow ports 32 allow fluid within the valve body 16 to flow through the plunger housing 30 into the interior thereof.

An important aspect of the invention is an adapter fitting 44 best illustrated in FIGS. 1-3, 9 and 10. Two different adapter fittings 44/44A are illustrated and configured in FIG. 10 in two different sizes and thread patterns. As can be appreciated, many different sizes and thread patterns can be provided on an adapter 44 to accommodate various types of sprinkler head fittings 14. The adapter fitting 44 has a valve body connection port 46 at a first end and a sprinkler head adapter connection port 48 at a second end. As noted above, the sprinkler head adapter connection portion 48 may comprise one of a plurality of different sizes and thread patterns to accommodate varying sprinkler head connection fittings.

The sprinkler head 14 and adapter 44 may be pre-assembled as a unit for installation into the valve body.

When the valve body 16 is connected to the supply pipe 10 and no adapter/sprinkler head unit 14/44 is installed (FIGS. 13 and 14), the valve plunger 28 resides in an extended, closed position with the plunger valve ports 36 positioned below the plunger housing valve ports 32 and flow being sealed by the two sealing rings 38 which straddle the plunger housing flow ports 32. It is of note that the sealing rings 38 prevent flow of water/fluid to the sprinkler head 14 in this position allowing removal and replacement of the sprinkler head 14.

The sealing ringer 38 also prevent water/fluid from being introduced into the interior space of the plunger assembly where the spring 42 is located. This is important because if this path is not sealed, water would leak into the spring cavity, and once filled, the valve could not be operated as you could not compress the water contained therein. The internal cavity must remain empty.

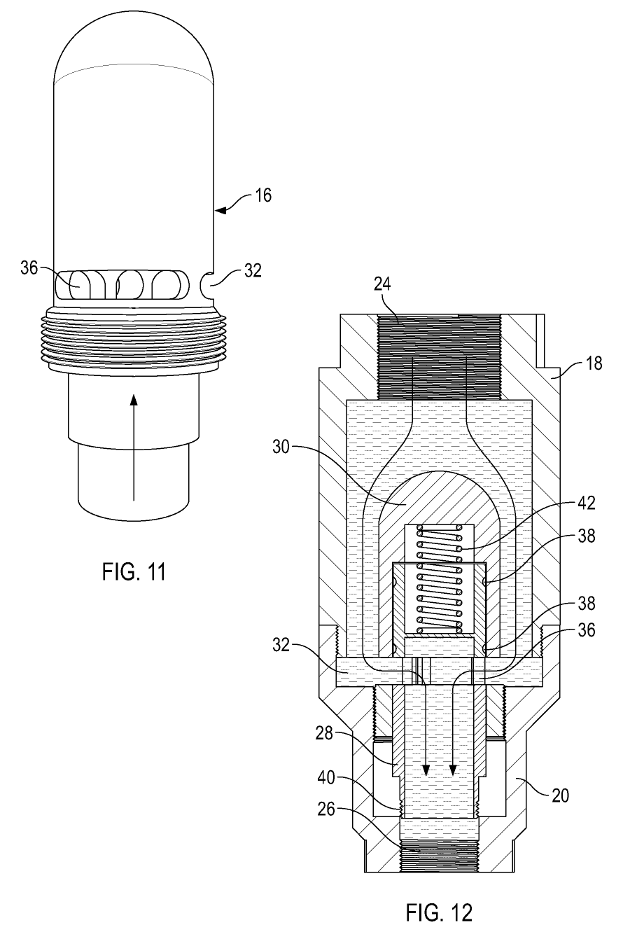

When the adapter/sprinkler head unit 14/44 is installed (FIGS. 11 and 12), i.e. threaded into the body portion in the connection port 26, the valve plunger 28 is pressed into the plunger housing 30 by the adapter fitting as it is threaded into the sprinkler head connection point 26. When fully installed, the adapter fitting depresses the valve plunger 28 thereby positioning the plunger valve ports 36 in alignment with the plunger housing ports 32. In this position, water/fluid is freely allowed to flow from the feed line 10 to the sprinkler head 14.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A self-closing sprinkler fire protection valve assembly, comprising:
an in-line valve body having a fire protection fluid supply connection port in a first valve body portion, a sprinkler head connection port in a second valve body portion, and a hollow cavity extending between said fluid supply and said sprinkler head connection ports;
a valve plunger housing received with the second valve body, the valve plunger housing having a radial flow port;
a valve plunger slidably received within an inner cavity created by said valve plunger housing and said second valve body portion, said valve plunger including a radial valve port and a neck positioned within said sprinkler head connection port in said second valve body portion, said valve plunger having an internal flow channel extending between said valve port and said neck,
said valve plunger body being slidably movable within said inner cavity between an extended closed position wherein said valve plunger port and said plunger housing port are not aligned thereby preventing fire protection fluid flow between said connection ports and a retracted open position wherein said valve plunger port and said plunger housing port are aligned when a sprinkler head connection is made to said sprinkler head connection port thereby allowing fire protection fluid flow between said connection ports;
a spring captured between the first end of the valve plunger and the inside of the valve plunger housing biasing said valve plunger to said normally extended position;
first and second seals positioned about an exterior of said valve plunger to engage an inner wall of said valve plunger housing, said seals preventing fluid flow through said valve plunger housing when a sprinkler head connection is not made to said sprinkler head connection port; and
a sprinkler head adapter fitting having a valve body connection port at a first end and a sprinkler head adapter connection port at a second end, wherein the sprinkler head adapter connection portion may comprise one of a plurality of different sprinkler head sizes and screw thread patterns to accommodate varying sprinkler head connection fittings.

2. A self-closing sprinkler valve assembly, comprising:
a valve body having a fluid supply connection port, a sprinkler head connection port, and a hollow cavity extending between said fluid supply and sprinkler head connection ports;
a valve plunger housing received within the valve body, the valve plunger housing having a radial flow port;
a valve plunger slidably received within an inner cavity created by said valve plunger housing and said the valve body, said valve plunger including a radial valve port and a neck positioned within said sprinkler head connection port, said valve plunger having an internal flow channel extending between said valve port and said neck,
said valve plunger body being slidably movable within said inner cavity between an extended closed position wherein said valve plunger port and said plunger housing port are not aligned, and a retracted open position wherein said valve plunger port and said plunger housing port are aligned when a sprinkler head connection is made to said sprinkler head connection port,
a spring captured between the valve plunger and the inside of the valve plunger housing biasing said valve plunger to said normally extended position; and
first and second seals positioned about an exterior of said valve plunger to engage an inner wall of said valve plunger housing, said seals preventing fluid flow through said valve plunger housing when a sprinkler head connection is not made to said sprinkler head connection port.

3. The self-closing sprinkler valve assembly of claim 2 further comprising:
a sprinkler head adapter fitting having a valve body connection port at a first end and a sprinkler head adapter connection port at a second end.

4. The self-closing sprinkler valve assembly of claim 3 wherein the sprinkler head adapter connection portion may comprise one of a plurality of different sizes and thread patterns to accommodate varying sprinkler head connection fittings.

5. The self-closing sprinkler valve assembly of claim 2 wherein the valve-body is configured as an in-line valve body.

6. The self-closing sprinkler valve assembly of claim 3 wherein the valve-body is configured as an in-line valve body.

7. The self-closing sprinkler valve assembly of claim 2 wherein the supply connection port is located in a first valve body portion and the sprinkler head connection port is located in a second valve body portion.

8. The self-closing sprinkler valve assembly of claim 3 wherein the supply connection port is located in a first valve body portion and the sprinkler head connection port is located in a second valve body portion.
